(19) United States
(12) Patent Application Publication
(10) Pub. No.: US 2026/0187746 A1
(43) Pub. Date: Jul. 2, 2026

(54) DIGITAL WATERMARKING FOR AUTHENTICITY AND SECURITY IN LIFECYCLE MANAGEMENT OF DIGITAL CONTENT

(71) Applicant: SAP SE, Walldorf (DE)

(72) Inventors: Jianmin Xue, Shanghai-Pudong (CN); Jiayu Wang, Shanghai-Pudong (CN)

(21) Appl. No.: 19/002,897

(22) Filed: Dec. 27, 2024

(51) Int. Cl. G06T 1/00; G06T 11/00

(52) U.S. Cl. CPC G06T 1/0064; G06T 11/10; G06T 2201/0061

(57) ABSTRACT

Methods, systems, and computer-readable storage media for converting a first set of values of first digital content to a second set of values, dividing a sub-set of values of the second set of values into a set of blocks, applying a transform to each block to provide, for each block, a frequency domain representation, for each block in the set of blocks, embedding a sub-set of watermark bits based on the parameters, executing an inverse transformation of the set of blocks to provide a modified second set of values representative of an image with a digital watermark in the second color space, converting the modified second set of values to a modified first set of values representative of the image with the digital watermark in the first color space, and providing second digital content including the image with the digital watermark.

### BACKGROUND

Enterprises use software systems to conduct operations. Example software systems can include, without limitation, enterprise resource management (ERP) systems, customer relationship management (CRM) systems, human capital management (HCM) systems, and the like. Software systems (e.g., ERP, CRM, HCM) generate digital data, generally referred to herein as digital content, that is representative of enterprise operations. In an enterprise context, information lifecycle management (ILM) systems manage digital data through its lifecycle from creation to destruction. Digital content can include sensitive information (e.g., personal information, competitive information, intellectual property) and/or information that is subject to regulatory requirements (e.g., privacy). Consequently, and over its lifecycle, the security of digital content must be protected to prevent leakage and ensure compliance with regulatory requirements.

In the modern digital age, distinguishing between authentic digital content and synthetic digital content is crucial due to, for example, risks to data security, dissemination of misinformation, intellectual property protection, and the like. The proliferation of generative artificial intelligence (GAI) raises the stakes for accurate identification of authentic digital content as compared to synthetic, AI-generated digital content.

### SUMMARY

Implementations of the present disclosure are directed to a digital watermarking system for embedding digital watermarks into and extracting digital watermarks from digital content. More particularly, implementations of the present disclosure are directed to digital watermarking of digital content to support execution of information lifecycle management (ILM) activities and data security.

In some implementations, actions include receiving first digital content comprising an image, initializing parameters for the first digital content, converting a first set of values of the first digital content to a second set of values, the first set of values being representative of the image in a first color space and the second set of values being representative of the image in a second color space, dividing a sub-set of values of the second set of values into a set of blocks, applying a transform to each block in the set of blocks to provide, for each block, a frequency domain representation of at least a portion of the image, for each block in the set of blocks, embedding a sub-set of watermark bits from a set of watermark bits into the block based on the parameters, the set of watermark bits being representative of a digital watermark representing at least one value for execution of an ILM activity, executing an inverse transformation of the set of blocks to provide a modified second set of values representative of the image with the digital watermark in the second color space, converting the modified second set of values to a modified first set of values representative of the image with the digital watermark in the first color space, and providing second digital content including the image with the digital watermark. Other implementations of this aspect include corresponding systems, apparatus, and computer programs, configured to perform the actions of the methods, encoded on computer storage devices.

These and other implementations can each optionally include one or more of the following features: actions further include storing the second digital content and the digital watermark in a datastore, the second digital content being indexed to the digital watermark within the datastore; the transform includes a discrete cosine transform; each block is represented as a matrix and for each block in the set of blocks, embedding a sub-set of watermark bits from a set of watermark bits into the block based on the parameters includes processing the matrix to provide a set of matrices, and embedding at least one watermark bit into a value of a matrix in the set of matrices; processing the matrix to provide a set of matrices comprises processing the matrix using singular value decomposition; actions further include processing the second digital content to determine the at least one value for execution of the ILM activity, and executing the ILM activity responsive to the at least one value; the ILM activity includes one of archiving of the image and destruction of the image; the first color space is a RGB color space and the second color space is a YUV color space; the first set of values includes, for each pixel in the image, a R channel value, a G channel value, and B channel value in the RGB color space, and the second set of values includes, for each pixel in the image, a Y channel value, a U channel value, and V channel value in the YUV color space; and the digital watermark includes one or more of a string of characters and an image of a machine-readable code.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIGS. 3A-3C depict representations of embedding digital watermarks into digital content in accordance with implementations of the present disclosure.

FIG. 4 depicts an example conceptual architecture in accordance with implementations of the present disclosure.

FIGS. 5A and 5B depict example processes that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to a digital watermarking system for embedding digital watermarks into and extracting digital watermarks from digital content. More particularly, implementations of the present disclosure are directed to digital watermarking of digital content to support execution of information lifecycle management (ILM) activities and data security.

Implementations can include actions of receiving first digital content comprising an image, initializing parameters for the first digital content, converting a first set of values of the first digital content to a second set of values, the first set of values being representative of the image in a first color space and the second set of values being representative of the image in a second color space, dividing a sub-set of values of the second set of values into a set of blocks, applying a transform to each block in the set of blocks to provide, for each block, a frequency domain representation of at least a portion of the image, for each block in the set of blocks, embedding a sub-set of watermark bits from a set of watermark bits into the block based on the parameters, the set of watermark bits being representative of a digital watermark representing at least one value for execution of an ILM activity, executing an inverse transformation of the set of blocks to provide a modified second set of values representative of the image with the digital watermark in the second color space, converting the modified second set of values to a modified first set of values representative of the image with the digital watermark in the first color space, and providing second digital content including the image with the digital watermark.

To provide further context for implementations of the present disclosure, and as introduced above, in the field of artificial intelligence (AI), so-called generative AI (GAI) has recently seen an explosion in popularity. GAI can be described as including foundation models that generate content based on training data. For example, foundation models can include LLMs, which are a form of GAI that can be used to generate text and perform other functions for a variety of use cases. In general, GAI can be used to generate any form of digital content, such as text, images, video, audio, documents (e.g., portable document format (PDF) documents), and the like. Accordingly, the rapid advancement in GAI has led to an increasing ability to create highly realistic, synthetic digital content. This progression has significantly blurred the lines between genuine digital content and artificial, AI-generated digital content, making it increasingly challenging to discern the authenticity of digital content. This situation presents serious concerns, particularly in areas such as, but not limited to news dissemination, content creation, and digital forensics, where the distinction between real digital content and synthetic digital content is crucial.

In the enterprise context, enterprises leverage software systems in support of enterprise operations, which implicates significant volumes of digital content. Enterprises implement ILM systems to manage digital data through its lifecycle. Digital content can include sensitive information (e.g., personal information, competitive information, intellectual property) and/or information that is subject to regulatory requirements (e.g., privacy). From a data volume perspective, as the amount of digital content continues to grow (e.g., exponentially), efficiently managing this vast volume of information through its entire lifecycle—from creation, retention, and auditing, to archiving, and eventual destruction—becomes increasingly complex. This growth strains existing data management systems and necessitates more sophisticated methods to efficiently track, categorize, and manage digital assets, particularly in ensuring the integrity and authenticity of the digital content.

Also, and from a digital security perspective, classifying and protecting sensitive data (e.g., credentials) embedded within digital content is paramount. The surge in data creation and sharing, compounded by sophisticated hacking and manipulation techniques, has heightened the need for robust security measures. As such, there is a pressing requirement for innovative solutions that can ensure the security of digital content. Among other issues, digital content needs to be safeguarded against unauthorized access and manipulation, while maintaining the confidentiality of sensitive data that is embedded therein.

In view of the above context, implementations of the present disclosure provide a digital watermark to mitigate risks, such as misinformation, authenticity, security, among others, and to protect intellectual property. As described in further detail herein, the digital watermark of the present disclosure is specifically designed for the identification of AI-generated digital content. Digital watermarking of the present disclosure is seamlessly integrated into ILM systems, offering a robust solution that verifies the authenticity of digital content across its entire lifecycle. In some implementations, the digital watermark is undetectable (e.g., invisible to the human eye) and is embedded within the digital content. The digital watermarking of the present disclosure, provides a powerful tool for ensuring compliance, enhancing traceability, and optimizing data management processes. The digital watermarking of the present disclosure is particularly effective in distinguishing AI-generated digital content, assuring that their origin and status are transparent and verifiable. This advancement not only fortifies data integrity and fosters trust, but also sets a new standard for managing digital content an age where GAI has become ubiquitous.

As described in further detail herein, the digital watermarking system of the present disclosure uses image processing techniques, such as a discrete cosine transform (DCT), singular value decomposition (SVD), and wavelet transformations, to embed a secure, invisible watermark in digital content. The digital watermarks of the present disclosure are imperceptible to the human eye, yet are easily verifiable to ensure unaltered content authenticity. Further, the digital watermarks of the present disclosure are resilient to manipulations such as rescaling, noise addition, rotation, and cropping.

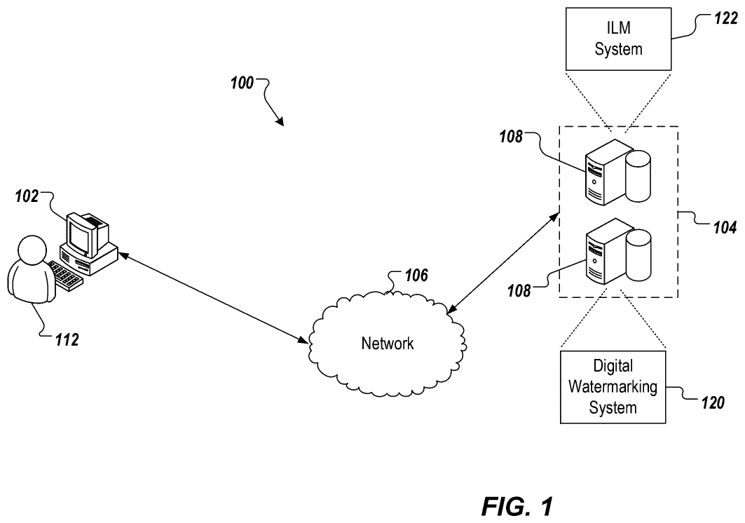

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a digital watermarking system 120 for embedding digital watermarks into and extracting watermarks from digital content. The server system 104 can also host an ILM system 122 to manage the lifecycles of digital content. As described in further detail herein, the digital watermarking system 120 and the ILM system 122 can cooperate over the lifecycles of digital content to ensure the origin and status of digital content of the lifecycles.

Implementations of the present disclosure are described in further detail herein with reference to example digital content, which includes digital images. It is contemplated, however, that aspects of the digital watermarking of the present disclosure can be applied to any appropriate form of digital content. In some examples, a digital image (also referred to as image herein) is represented as data (e.g., stored in an image file), the data providing values for each of a plurality of pixels that the image is composed of. In some examples, each pixel includes respective values for a blue channel, a green channel, and a red channel (e.g., RGB format).

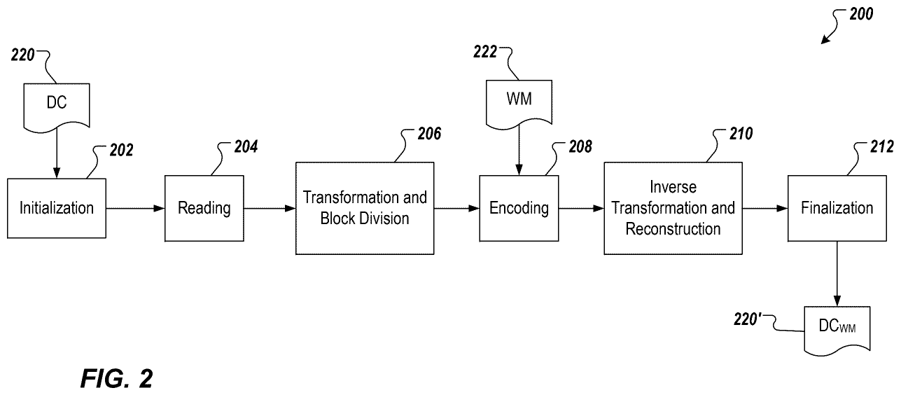

FIG. 2 depicts an example conceptual architecture 200 in accordance with implementations of the present disclosure. In some examples, the conceptual architecture 200 provides for embedding digital watermarks into images. In the depicted example, the example conceptual architecture 200 includes an initialization module 202, a reading module 204, a transformation and block division module 206, an encoding module 208, an inverse transformation and reconstruction module 210, and a finalization module 212. The conceptual architecture 200 is representative of at least a portion of a digital watermarking system of the present disclosure. As described in further detail herein, digital content 220 is processed through the conceptual architecture 200 to provide watermarked digital content 220′ by encoding a digital watermark 222 into the digital content 220.

In further detail, the digital content 220 is processed by the initialization module 202 to initialize parameters. Example parameters can include a size of blocks in the digital content 220, password, embedding mode, and the like. The digital content 220 is read and is converted by the reading module 204. For example, the digital content 220, being an image, is read, during which values of individual pixels are determined. For example, and as introduced above, the image is represented as data (e.g., stored in an image file), the data providing values for each of a plurality of pixels that the image is composed of. In some examples, each pixel includes respective values for a blue channel, a green channel, a red channel, and an alpha channel, where alpha represents the opaqueness of the respective pixel (e.g., RGB format). In some examples, each channel has a value ranging from 0 to 255 (e.g., 8-bits for a total of 24-bits per pixel). The reading module 204 converts the data of the image to 32-byte floating point numbers.

In some examples, pixel values (e.g., RGB values) are initially represented as integers ranging from 0 to 255 for each channel. These integer values are normalized to a range of 0.0 to 1.0 by dividing each value by 255. This normalization converts the data into a floating-point representation, which allows for greater precision during mathematical operations. The normalized values are then stored as 32-bit floating-point numbers to ensure compatibility with various image processing techniques, such as transformation and encoding. For instance, if a pixel has RGB values (64, 128, 192), the normalized floating-point values would be approximately (0.251, 0.502, 0.753). This conversion is crucial for accurately embedding and later extracting watermarks while maintaining the visual quality of the digital content.

The reading module 204 converts the image to the YUV color space, which includes a Y channel (luminance), a U channel (chroma), and a V channel (chroma). In some examples, each channel is 8-bits for a total of 24-bits per pixel. In some examples, the conversion of 32-bit floating-point numbers to YUV color space is achieved using OpenCV's cv2.cvtcolor function. OpenCV implements this transformation using a predefined matrix operation that is consistent with standard YUV color space definitions. The process preserves precision, with Y, U, and V channels represented as floating-point values. In some examples, color conversion is performed using OpenCV's cv2.COLOR_BGR2YUV, which receives the input image in the BGR format (the default for OpenCV) and converts it to the YUV format. The YUV format separates brightness (Y) from color information (U and V) using a standard matrix multiplication. For example, for each pixel, the transformation is:

$$[ \begin{matrix}Y \\ U \\ V\end{matrix} ] = [ \begin{matrix}0.299 & 0.587 & 0.114 \\ - 0.14713 & - 0.28886 & 0.436 \\ 0.615 & - 0.51499 & - 0.10001\end{matrix} ] \cdot [ \begin{matrix}B \\ G \\ R\end{matrix} ]$$

Here, BBB, GGG, and RRR are the floating-point values of the blue, green, and red channels (in the range [0, 255] if unnormalized). The cv2.cytcolor function outputs the YUV values, with each channel represented as a 32-bit floating-point number because the input was in float32. Each channel can then be processed independently for further operations.

In some examples, the reading module 204 adds padding to make the dimensions of the image even. The padding ensures that the image dimensions are even, which is enables certain image processing operations. For example, OpenCV's cv2.copyMakeBorder can be used to add rows and columns of black padding at the bottom and right sides, calculated based on the remainder of the image dimensions divided by 2.

In further detail, the function cv2.copyMakeBor der is used to add padding (white edges) to the image to ensure its dimensions are even. This is achieved by checking if the height and width of the image are divisible by 2. If not, padding is added to the bottom or right side of the image. For example, the required padding can be determined as:
Height Padding: If the height (self.img.shape[0]) is odd, one row of padding is added to the bottom.
Width Padding: If the width (self.img.shape[1]) is odd, one column of padding is added to the right.
   The cv2.copyMakeBorder function is used to add the padding and allows for specifying the number of pixels to add to each side of the image. By way of non-limiting example, suppose the original image dimensions are 101×203101 \times 203101×203 (height×\times×width):
Height (101): Odd, so 1 row is added to the bottom.
Width (203): Odd, so 1 column is added to the right.
Resulting Dimensions: 102×204102 \times 204102×204.

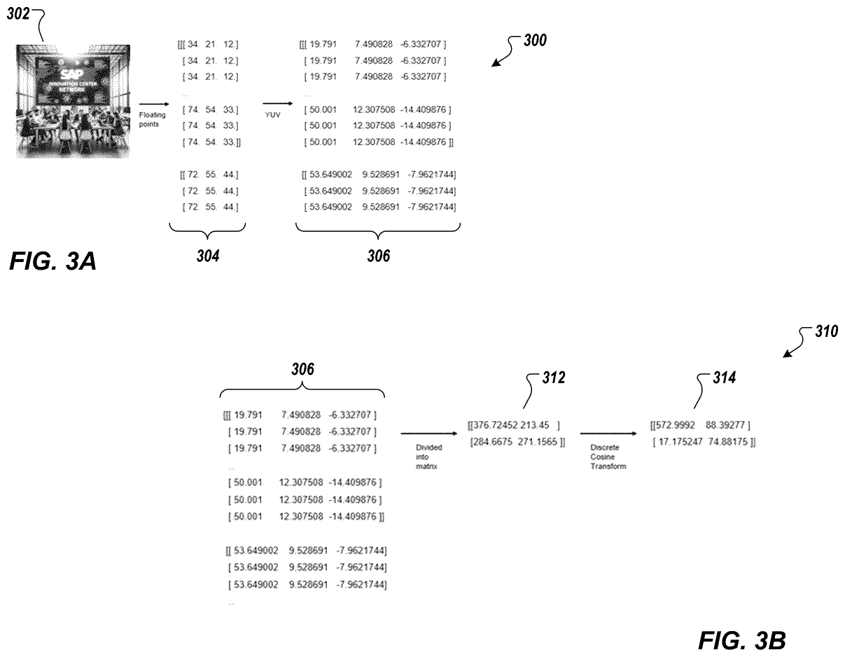

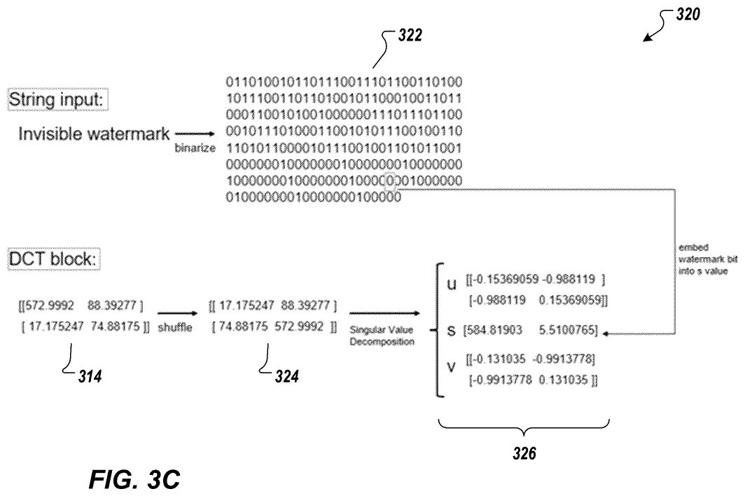

FIG. 3A depicts a representation 300 of converting an image 302 to a set of 32-bit floating point numbers 304 and to a set of YUV color space values 306 in accordance with implementations of the present disclosure.

Referring again to FIG. 2, the transformation and block division module 206 divides the Y channel (luminance) of the image into blocks, each block being provided as a matrix of values. In some examples, the block division module 206 not only divides Y channel, but each of the YUV channels. In further detail, block shapes are determined, whereby self.ca_shape is used to compute the dimensions of the image after halving each dimension. This halving is typical in multi-resolution processing or transformations like Discrete Wavelet Transform (DWT), which is used here. In some examples, self.ca_block_shape calculates the shape of the blocks into which the image will be divided. It divides the halved image dimensions (self.ca_shape) by the dimensions of the block size (self.block_shape), resulting in a 4-dimensional block structure, where the first two dimensions correspond to the number of blocks in rows and columns and the last two dimensions correspond to the size of each block in pixels.

In some examples, np.lib.stride_tricks.as_strided is used for block division to efficiently divide the image into non-overlapping blocks. It does this by reshaping the image data into a 4D array without copying the data. More particularly, the strides parameter determines how to step through the image array to generate the blocks. For example, the first stride corresponds to stepping by the height of a block to form rows of blocks, the second stride corresponds to stepping by the width of a block to form columns of blocks, and the remaining strides ensure that each block retains its internal structure in the 4D representation.

In some examples, a transformation is applied to each block to provide a frequency domain representation of the image. In some examples, the DCT is applied to each block to provide the frequency domain representation of the image. In general, the DCT can be described as expressing a finite sequence of data points in terms of a sum of cosine functions oscillating at different frequencies.

FIG. 3B depicts a representation 310 of dividing the set of YUV color space values 306 of FIG. 3A into a matrix of blocks 312 and using the DCT to transform the matrix of blocks 312 to provide a frequency domain representation 314 of the image 302.

Referring again to FIG. 2, the encoding module 208 encodes the digital watermark 222 into the frequency domain representation. In some examples, the digital watermark 222 is provided as string input (e.g., text string). In some examples, the digital watermark 222 is provided as a machine-readable code (e.g., QR code). The digital watermark 222 is binarized to a binary string. To embed the digital watermark 222, for each block, the watermark bits are embedding using SVD, which can be generally described as factorizing of a matrix into multiple matrices. More particularly, SVD is used to modify singular values of DCT coefficients based on the watermark bits and a set of parameters.

In some examples, the set of parameters includes self.d1, self.d2, wm_bit, shuffler, and self.block_shape. Here, self.d1 and self.d2 control the scaling and quantization of the singular values during watermark embedding and determine the granularity and strength of the modifications to the singular values. Further, wm_bit is the watermark represented by as a binary string, where each bit corresponds to 0 or 1. Each bit is embedded into the singular values of the block's DCT coefficients. Also, shuffler is a sequence that determines how the DCT coefficients are shuffled and unshuffled. This adds an additional layer of encryption to obscure the watermark further. Finally, self.block_shape specifies the dimensions of the block being processed to ensure that all operations (e.g., reshaping, DCT, and SVD) conform to a consistent structure.

Use of the set of parameters is now described. The Discrete Cosine Transform (DCT) is applied to a block of pixel values to transform it into the frequency domain. With regard to shuffling (encryption), the DCT coefficients are shuffled using the shuffler sequence to add a layer of security. The shuffled DCT block is decomposed into three matrices (u, s, and v) using SVD. The binary watermark bit (wm_1) is embedded by modifying the singular values (s). Here, self.d1 and self.d2 control the quantization of the singular values, ensuring changes are subtle but detectable. The watermark bit (wm_1) determines how the singular values are adjusted (e.g., adding ½*wm_1).

In some examples, inverse SVD and unshuffling, whereby the modified singular values are recombined using the inverse of SVD and the coefficients are unshuffled to their original order. The final watermarked block is obtained by applying the inverse DCT. This effectively hides the watermark in the image while preserving its visual quality.

In further detail, each block of DCT coefficients is provided as an m×n matrix (A). Each block is processed through SVD to provide a set of matrices that includes a m×m matrix (U), a m×n matrix (S), and a n×n matrix (V). In some examples, a sub-set of watermark bits are embedded into s values represented in the matrix (S).

FIG. 3C depicts a representation 320 of embedding a binarized watermark 322 into the frequency domain representation 314 of the image 302. As depicted in FIG. 3C, the frequency domain representation 314 is shuffled to provide a shuffled representation 324 that is processed using SVD to provide a set of matrices 326, the binarized watermark being embedded into the S matrix in the set of matrices 326.

Referring again to FIG. 2, the inverse transformation and reconstruction module 210 executes an inverse transformation of watermarked blocks into the spatial domain, which results in a watermarked image. The finalization module 212 finalizes the watermarked image by, for example, removing any added padding and converting the watermarked image back to the RGB color space. If the original image had an alpha channel (transparency), the alpha channel is also preserved. The result is the watermarked digital content 220′. In some examples, the digital watermark 222 is stored and is indexed to the watermarked digital content 220′. For example, the watermarked digital content 220′ can be assigned a unique identifier that the digital watermark 222 can be indexed to. In some examples, the set of parameters that is used to embed the digital watermark is stored with the digital watermark.

In accordance with implementations of the present disclosure, the authenticity of digital content can be confirmed by extracting digital watermarks and comparing the extracted digital watermarks to the digital watermarks embedded into the digital content.

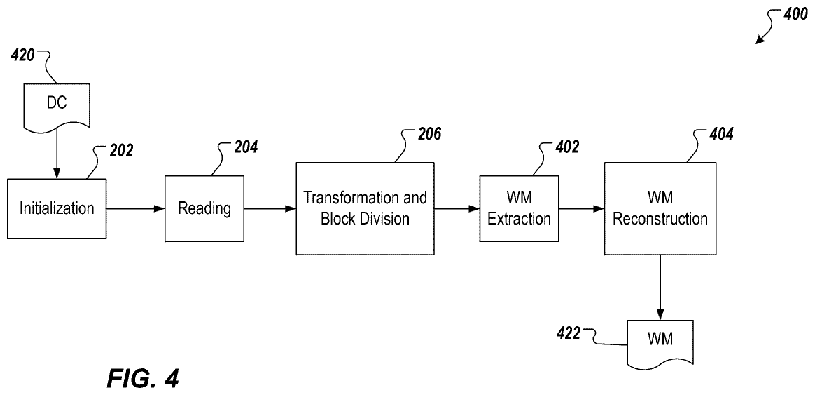

In further detail, FIG. 4 depicts an example conceptual architecture 400 in accordance with implementations of the present disclosure. In some examples, the conceptual architecture 400 provides for extracting digital watermarks from images. In the depicted example, the example conceptual architecture 400 includes the initialization module 202, the reading module 204, the transformation and block division module 206, a watermark extraction module 402, and a watermark reconstruction module 404. The conceptual architecture 400 is representative of at least a portion of the digital watermarking system of the present disclosure. As described in further detail herein, digital content 420 is processed through the conceptual architecture 400 to extract a watermark 422 from the digital content 420.

The digital content 420 is processed by the initialization module 202 to initializing parameters. Example parameters can include a size of blocks in the digital content 220, password, embedding mode, and the like. The digital content 420 is read and is converted by the reading module 204. For example, the digital content 420, being an image, is read, during which values of individual pixels are determined. The reading module 204 converts the image to 32-bit floating point numbers and converts the image to the YUV color space from the RGB color space. In some examples, the reading module 204 adds padding to make the dimensions of the image even.

The transformation and block division module 206 divides the Y-channel (luminance) of the image into a matrix of blocks. A transformation is applied to each block to provide a frequency domain representation of the image. In some examples, the DCT is applied to each block to provide the frequency domain representation of the image.

For each block in the frequency domain representation, the watermark extraction module 402 extracts watermark bits using a method based on the SVD technique and the same set of parameters used to embed the digital watermark. In some examples, the watermark extraction module 402 checks the modified singular values of the DCT coefficients to recover the watermark bits.

With regard to watermark extraction, the watermark extraction module 402 uses the SVD technique and the set of parameters that were used for embedding the watermark to extract the watermark bits from each block. The process involves DCT transformation, SVD, and watermark bit extraction as described herein. For example, using DCT transformation, the block is transformed back into the frequency domain and the DCT coefficients are shuffled using the same shuffler sequence used during embedding to align the data. SVD is applied to the shuffled DCT coefficients, resulting in the decomposition of the block into three matrices: u, s, and v.

To extract the watermark bits, the modified singular values (s[0] and s[1]) are analyzed to recover the embedded watermark bits. More particularly, the condition (s[0]% self.d1>self.d1/2) checks whether the remainder of the singular value s[0] divided by self.d1 exceeds half of self.d1, to determine whether the watermark bit is 1 or 0. Also, if self.d2 is used, a secondary bit is extracted from s[1] using the same logic, and the watermark bits are combined, as described in further detail herein. As described herein, this process effectively reverses the embedding process, recovering the watermark bits embedded into the singular values of the block.

The watermark reconstruction module 404 combines the extracted watermark bits from all blocks to reconstruct and output the digital watermark 422 (e.g., string, QR code image). More particularly, the watermark reconstruction module 404 collects the extracted watermark bits from all processed blocks and combines them to reconstruct the complete digital watermark. The process includes sequential assembly, bit-to-watermark conversion, and output. With regard to sequential assembly, the extracted watermark bits from all blocks are arranged in their original order, determined during the embedding phase. With regard to bit-to-watermark conversion, the binary sequence of watermark bits is decoded into its original representation. For text strings, the binary bits are converted back to ASCII characters. For machine-readable codes (e.g., QR codes), the binary data is reorganized into the appropriate format (e.g., matrix) to recreate the original image. The reconstructed watermark is outputted as a string, QR code image, or other specified formats.

In accordance with implementations of the present disclosure, the digital watermark 422 can be compared to the original watermark embedded into the digital content 420 to determine whether they are the same. For example, the digital content 420 can be the digital content 220′ of FIG. 2. Accordingly, the digital watermark 422 can be compared to the digital watermark 222 to determine whether they are the same. In some examples, to determine whether the extracted watermark 422 matches the original watermark 222 embedded in the digital content 420, various comparison techniques can be used. Example comparison techniques can include bitwise comparison (compare the binary representation of the extracted watermark with the original watermark bit-by-bit to ensure exact matching), Hamming distance (determining the Hamming distance (e.g., the number of differing bits) between the two binary representations, where a Hamming distance of 0 indicates an exact match), image similarity metrics (calculate similarity using methods like structural similarity index (SSIM) or pixel-wise comparison to determine if the extracted watermark matches the original), error-correction (if the watermark includes error-correction codes (e.g., Reed-Solomon coding in QR codes), the extracted watermark can be checked and corrected to match the original), and hashing (both the original and extracted watermarks can be hashed using a cryptographic hash function (e.g., SHA-256), and the resulting hashes can be compared. If the hashes are identical, the watermarks are the same). If the digital watermarks 222, 422 are the same, the authenticity of the digital content 420 is assured. If the digital watermarks 222, 422 are not the same, the authenticity of the digital content 420 is not assured.

As discussed herein, the digital watermarking system of the present disclosure can cooperate with a ILM system over the lifecycles of digital content to ensure the origin and status of digital content of the lifecycles. In general, ILM is a continuous and dynamic process that ensures data integrity, security, and compliance from inception to final disposition. The lifecycle can include data creation, compliance management, data retention, data auditing, data archiving, and data destruction.

Data creation in the inception point where data is generated or captured, that can be embedded with a digital watermark to establish authenticity and ownership from the outset. In compliance management, as data is utilized and shared, digital watermarking can be used to ensure that the data adheres to legal, regulatory, and organizational policies, maintaining integrity and compliance. In data retention, during its active life, data is retained according to governance policies; digital watermarking provides an audit trail, reinforcing data integrity and enabling efficient retrieval. In data auditing, regular audits assess and verify data usage and compliance. The digital watermark serves as an indelible proof of data provenance and changes over time, ensuring transparency and accountability. In data archiving, when active use diminishes, data is archived. The digital watermark persists, ensuring that even in long-term storage, the data's authenticity remains verifiable. In data destruction, at the end of its lifecycle, data is securely destroyed to protect sensitive information. Digital watermarking ensures complete and compliant data eradication, leaving a clear record of the data's lifecycle end.

In the context of ILM, the digital watermarking of the present disclosure, presents a transformative technology, offering a multifaceted approach to data authenticity, integrity, and compliance. As enterprises grapple with the challenges of managing vast amounts of digital content, the digital watermarking of the present disclosure can be implemented to not only ensures the authenticity and integrity of data throughout its lifecycle, but also align with any applicable legal and regulatory frameworks. For example, by embedding invisible, yet detectable, digital watermarks within data, a seamless way to trace, manage, and protect information is provided from creation to eventual archiving or destruction. This integration into TLM systems addresses issues around data security, compliance, and efficient management in an increasingly digitalized world, thereby reinforcing the trust and reliability of information systems.

In some implementations, the ILM system can operate in view of digital watermarking in data management policies. For example, an example policy can provide that each data object (digital content) to be archived or destroyed will have clearly defined business semantics and content. In the context TLM, defining business semantics and content are preconditions to data operation. Integrating digital watermarking into this framework elevates data management by ensuring that business contexts are consistently understood and maintained throughout the lifecycle of the data. Here, digital watermarking of the present disclosure can directly embed this information within the data itself, facilitating accurate and efficient management, archiving, and destruction of data.

For example, digital watermarking can be applied in the context of file type classification. In this context, digital watermarks can be used to categorize files into distinct types (e.g., financial documents, sales records). This classification enables appropriate understanding and managing of data. In some implementations, a customized name table can be provided for file types. In some examples, the name table enumerates all available file types and provides a taxonomy for data classification. In some examples, specific criteria can be established for classifying files into the types based on attributes encoded in the digital watermark. More particularly, by determining a type from the digital watermark, it can accurately be determined which data should be archived or destroyed, ensuring that actions like archiving and destruction are conducted precisely and relevantly.

In further detail, a digital watermark can be extracted from digital content (e.g., as described herein with reference to FIG. 4) and the digital watermark can indicate the type. The type can be used as an index to the name table to determine an archiving or destruction decision, which is then executed (e.g., the digital content is archived or destroyed).

In some implementations, digital watermarking can be applied in the context enhancing selection and archiving. For example, digital watermarks enhance a selection process by clearly indicating whether data, especially from ongoing enterprise operations, is ready for archiving. In some examples, a uniform user experience can be provided through a central service interface across enterprise systems (e.g., ERP, CRM, HCM), which enables archivability of data to be checked anchored by the information recorded in the digital watermark.

In some examples, a test mode can be provided in the ILM system and detailed logs can be provided to indicate instances where data is deemed non-archivable based on digital watermark analysis. In the test mode, the system analyzes digital watermarks embedded in the data to verify critical attributes such as retention period compliance (ensuring that the data has reached the minimum retention time), data completeness (verifying that all necessary components (e.g., attached documents, metadata) are intact and accessible), and user-specific constraints (checking for any restrictions or exemptions tagged within the digital watermark). In some examples, a digital watermark can encode key information that determines the archivability of a data object, such as archival status (whether the data is flagged as ready for archiving or still under review), ownership and access permissions (indicating whether the proper permissions for archiving are in place), and compliance information (confirming adherence to regulations or internal policies).

With regard to analysis, when data is processed in the test mode, the ILM system extracts and analyzes the digital watermark to evaluate the conditions necessary for archiving. Examples of checks can include policy conformance (whether the watermark indicates non-compliance with regulatory or internal policies, the data is marked as non-archivable), data dependencies (whether the watermark encodes references to dependencies (e.g., linked records or incomplete workflows), the absence of these components can result in non-archivability), and retention periods (whether the watermark indicates that the retention period has not yet elapsed, the data will not be archived.

In some implementations, digital watermarking can be applied in the context of preventing changes to archived data. For example, digital watermarks can be used to ensure immutability of the data, where a changes to a digital watermark indicate changes to the underlying data. Here, the digital watermark serves as a security tool to authenticate and verify the integrity of archived data, thus preventing unauthorized alterations. In some examples, archiving can occur in cooperation with third-party storage vendors. Enterprises can interact with such third-party storage vendors using protocols that exchange retention information, where digital watermarks act as a verifier of the authenticity of archived data.

Another example policy can provide that destruction of data shall only be performed in full accordance with valid legal retention policies for compliance with audit regulations. In the context of ILM, ensuring that destruction of data complies with applicable regulations is essential. Here, the digital watermarking of the present disclosure offers an innovative way to ensure data is managed and destroyed in accordance with legal retention policies, for example. By encoding specific retention policies and other legal requirements directly in the data using digital watermarks, traceability and adherence to legal requirements can be provided. This also facilitates easy tracking and verification during audits, ensuring compliance with legal standards. This not only customizes the data handling process to individual legal requirements but also ensures that every piece of data is treated in accordance with its designated policy.

In some examples, digital watermarking can be integrated with an information retention manager (IRM) to facilitate enhanced management of data lifecycle actions, such as destroy and snapshot. Digital watermarks can carry detailed information about the object types, audit areas, and policies relevant to each data piece, aligning with IRM functionalities for comprehensive data governance.

In the context of data destruction, digital watermarks can be used to verify that the data scheduled for destruction complies with the established retention policies. This is helpful in scenarios where data must be irrecoverably destroyed following specific legal mandates. In some examples, the digital watermark retains a traceable footprint, enabling enterprises to demonstrate compliance even after data destruction. This is helpful for meeting regulatory requirements and for providing evidence in audits.

In some implementations, the digital watermarking system of the present disclosure can provide a tiered credential classification for digital content. More particularly, different levels of verification and security can be assigned to digital content based on the sensitivity and importance of the digital content. For example, digital content that includes intellectual property of an enterprise may have more strict verification and security than digital content that is absent intellectual property or other security-sensitive information. This approach not only enhances the security infrastructure, but also provides granular control over content management and distribution within enterprise ecosystems.

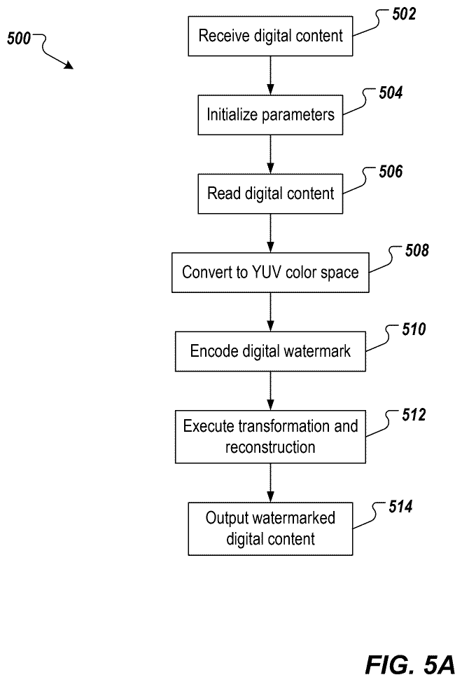

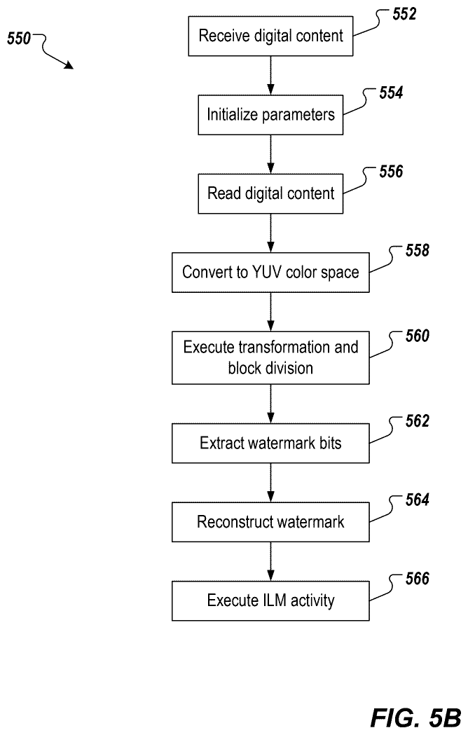

FIG. 5A depicts an example process 500 that can be executed in accordance with implementations of the present disclosure. In some examples, the example process 500 is provided using one or more computer-executable programs executed by one or more computing devices.

Digital content is received (502). For example, and as described herein, the digital watermarking system of the present disclosure can receive digital content representative of operations of an enterprise. Parameters are initialized (504). For example, and as described herein with reference to FIG. 2, the digital content 220 is processed by the initialization module 202 to initialize parameters. Example parameters can include a size of blocks in the digital content 220, password, embedding mode, and the like. The digital content is read (506) and is converted to YUV color space (508). For example, and as described herein, the digital content 220 is read and is converted by the reading module 204. For example, the digital content 220, being an image, is read, during which values of individual pixels in the RGB color space are determined and are converted to the YUV color space.

The digital watermark is encoded (510). For example, and as described herein, the transformation and block division module 206 divides the Y channel (luminance) of the image into blocks, each block being provided as a matrix of values and the DCT is applied to each block to provide a frequency domain representation of the image. Further, each block of DCT coefficients is processed through SVD to provide a set of matrices that includes a m×m matrix (U), a m×n matrix (S), and a n×n matrix (V). In some examples, a sub-set of watermark bits are embedded into s value represented in the matrix (S).

Transformation and reconstruction are executed (512) and the watermarked digital content is output (514). For example, and as described herein, the inverse transformation and reconstruction module 210 executes an inverse transformation of watermarked blocks into the spatial domain, which results in a watermarked image. The finalization module 212 finalizes the watermarked image by, for example, removing any added padding and converting the watermarked image back to the RGB color space. If the original image had an alpha channel (transparency), the alpha channel is also preserved. The result is the watermarked digital content 220′. In some examples, the digital watermark 222 is stored and is indexed to the watermarked digital content 220′. For example, the watermarked digital content 220′ can be assigned a unique identifier that the digital watermark 222 can be indexed to. In some examples, the set of parameters that is used to embed the digital watermark is stored with the digital watermark.

FIG. 5B depicts an example process 550 that can be executed in accordance with implementations of the present disclosure. In some examples, the example process 550 is provided using one or more computer-executable programs executed by one or more computing devices.

Digital content is received (552). For example, and as described herein, the digital watermarking system of the present disclosure can receive digital content representative of operations of an enterprise, the digital content being subject to one or more ILM activities. For example, the digital content can be received to check a digital watermark encoded therein for authenticity, security, and/or execution of an ILM activity. Parameters are initialized (554). For example, and as described herein with reference to FIG. 4, the digital content 420 is processed by the initialization module 202 to initialize parameters. Example parameters can include a size of blocks in the digital content 420, password, embedding mode, and the like. The digital content is read (556) and is converted to YUV color space (558). For example, and as described herein, the digital content 420 is read and is converted by the reading module 204. For example, the digital content 420, being an image, is read, during which values of individual pixels in the RGB color space are determined and are converted to the YUV color space.

Transformation and block division are executed (560). For example, and as described herein, the transformation and block division module 206 divides the Y-channel (luminance) of the image into a matrix of blocks. A transformation is applied to each block to provide a frequency domain representation of the image. In some examples, the DCT is applied to each block to provide the frequency domain representation of the image. Watermark bits are extracted (562) and a digital watermark is reconstructed (564). For example, and as described herein, for each block in the frequency domain representation, the watermark extraction module 402 extracts watermark bits using a method based on the SVD technique and the same set of parameters used to embed the digital watermark. In some examples, the watermark extraction module 402 checks the modified singular values of the DCT coefficients to recover the watermark bits. The watermark reconstruction module 404 combines the extracted watermark bits from all blocks to reconstruct and output the digital watermark 422 (e.g., string, QR code image).

An ILM activity is executed (566). For example, and without limitation, digital watermarking can be applied in the context of preventing changes to archived data. For example, digital watermarks can be used to ensure immutability of the data, where a changes to a digital watermark indicate changes to the underlying data. Here, the digital watermark serves as a security tool to authenticate and verify the integrity of archived data, thus preventing unauthorized alterations.

As described herein, the digital watermarking of the present disclosure provides one or more technical advantages. For example, the digital watermarks of the present disclosure are invisible (e.g., imperceptible to the unaided human eye) and are easily verifiable to ensure unaltered content authenticity. Further, the digital watermarks of the present disclosure are resilient to manipulations such as rescaling, noise addition, rotation, and cropping. From an enterprise security standpoint, the digital watermarking of the present disclosure not only guards against unauthorized modification of digital content, but also serves to verify content source (provenance) and authenticity, which are crucial in maintaining confidentiality and integrity. From the ILM perspective, the digital watermarking of the present disclosure enables ILM-relevant information, such as origin, handling, and retention policies to be directly embedded into the digital content. This enables, among other things, automation of retention management, as the digital watermarks can contain metadata on the lifespan of the digital content, guiding automated systems in data archiving and deletion processes.

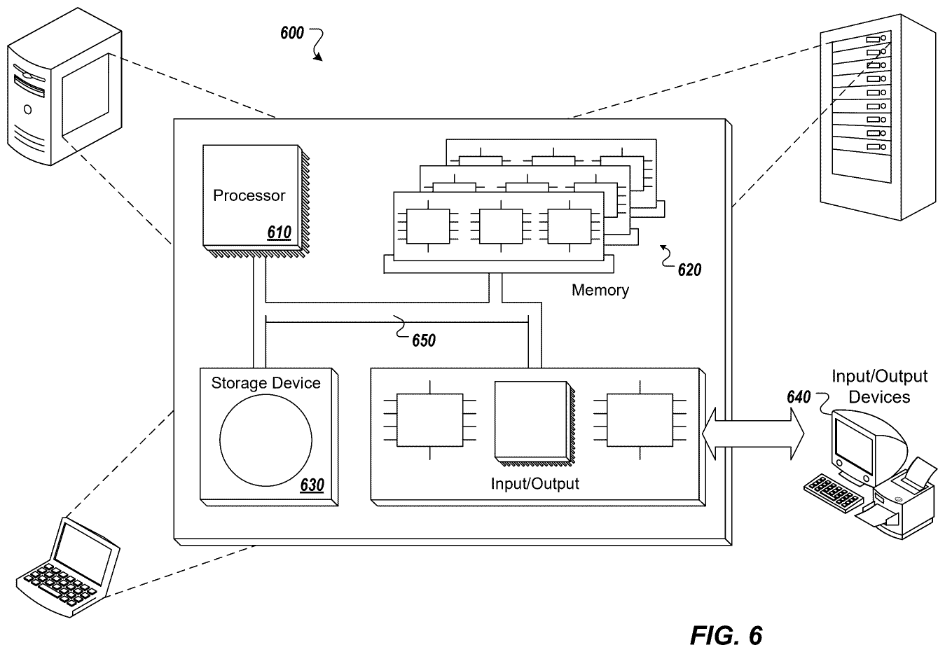

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for digital watermarking of digital content for information lifecycle management (ILM), the method being executed by one or more processors and comprising:
receiving first digital content comprising an image;
initializing parameters for the first digital content;
converting a first set of values of the first digital content to a second set of values, the first set of values being representative of the image in a first color space and the second set of values being representative of the image in a second color space;
dividing a sub-set of values of the second set of values into a set of blocks;
applying a transform to each block in the set of blocks to provide, for each block, a frequency domain representation of at least a portion of the image;
for each block in the set of blocks, embedding a sub-set of watermark bits from a set of watermark bits into the block based on the parameters, the set of watermark bits being representative of a digital watermark representing at least one value for execution of an ILM activity;
executing an inverse transformation of the set of blocks to provide a modified second set of values representative of the image with the digital watermark in the second color space;
converting the modified second set of values to a modified first set of values representative of the image with the digital watermark in the first color space; and
providing second digital content comprising the image with the digital watermark.

2. The method of claim 1, further comprising storing the second digital content and the digital watermark in a datastore, the second digital content being indexed to the digital watermark within the datastore.

3. The method of claim 1, wherein the transform comprises a discrete cosine transform.

4. The method of claim 1, wherein each block is represented as a matrix and for each block in the set of blocks, embedding a sub-set of watermark bits from a set of watermark bits into the block based on the parameters comprises:
processing the matrix to provide a set of matrices; and
embedding at least one watermark bit into a value of a matrix in the set of matrices.

5. The method of claim 4, wherein processing the matrix to provide a set of matrices comprises processing the matrix using singular value decomposition.

6. The method of claim 1, further comprising:
processing the second digital content to determine the at least one value for execution of the ILM activity; and
executing the ILM activity responsive to the at least one value.

7. The method of claim 6, wherein the ILM activity comprises one of archiving of the image and destruction of the image.

8. The method of claim 1, wherein the first color space is a RGB color space and the second color space is a YUV color space.

9. The method of claim 8, wherein:
the first set of values comprises, for each pixel in the image, a R channel value, a G channel value, and B channel value in the RGB color space; and
the second set of values comprises, for each pixel in the image, a Y channel value, a U channel value, and V channel value in the YUV color space.

10. The method of claim 1, wherein the digital watermark comprises one or more of a string of characters and an image of a machine-readable code.

11. A non-transitory computer-readable storage medium coupled to one or more processors and having instructions stored thereon which, when executed by the one or more processors, cause the one or more processors to perform operations for digital watermarking of digital content for information lifecycle management (ILM), the operations comprising:
receiving first digital content comprising an image;
initializing parameters for the first digital content;
converting a first set of values of the first digital content to a second set of values, the first set of values being representative of the image in a first color space and the second set of values being representative of the image in a second color space;
dividing a sub-set of values of the second set of values into a set of blocks;
applying a transform to each block in the set of blocks to provide, for each block, a frequency domain representation of at least a portion of the image;
for each block in the set of blocks, embedding a sub-set of watermark bits from a set of watermark bits into the block based on the parameters, the set of watermark bits being representative of a digital watermark representing at least one value for execution of an ILM activity;
executing an inverse transformation of the set of blocks to provide a modified second set of values representative of the image with the digital watermark in the second color space;
converting the modified second set of values to a modified first set of values representative of the image with the digital watermark in the first color space; and
providing second digital content comprising the image with the digital watermark.

12. The non-transitory computer-readable storage medium of claim 11, wherein operations further comprise storing the second digital content and the digital watermark in a datastore, the second digital content being indexed to the digital watermark within the datastore.

13. The non-transitory computer-readable storage medium of claim 11, wherein the transform comprises a discrete cosine transform.

14. The non-transitory computer-readable storage medium of claim 11, wherein each block is represented as a matrix and for each block in the set of blocks, embedding a sub-set of watermark bits from a set of watermark bits into the block based on the parameters comprises:
processing the matrix to provide a set of matrices; and
embedding at least one watermark bit into a value of a matrix in the set of matrices.

15. The non-transitory computer-readable storage medium of claim 14, wherein processing the matrix to provide a set of matrices comprises processing the matrix using singular value decomposition.

16. A system, comprising:
a computing device; and
a computer-readable storage device coupled to the computing device and having instructions stored thereon which, when executed by the computing device, cause the computing device to perform operations for digital watermarking of digital content for information lifecycle management (ILM), the operations comprising:
receiving first digital content comprising an image;
initializing parameters for the first digital content;
converting a first set of values of the first digital content to a second set of values, the first set of values being representative of the image in a first color space and the second set of values being representative of the image in a second color space;
dividing a sub-set of values of the second set of values into a set of blocks;
applying a transform to each block in the set of blocks to provide, for each block, a frequency domain representation of at least a portion of the image;
for each block in the set of blocks, embedding a sub-set of watermark bits from a set of watermark bits into the block based on the parameters, the set of watermark bits being representative of a digital watermark representing at least one value for execution of an ILM activity;
executing an inverse transformation of the set of blocks to provide a modified second set of values representative of the image with the digital watermark in the second color space;
converting the modified second set of values to a modified first set of values representative of the image with the digital watermark in the first color space; and
providing second digital content comprising the image with the digital watermark.

17. The system of claim 16, wherein operations further comprise storing the second digital content and the digital watermark in a datastore, the second digital content being indexed to the digital watermark within the datastore.

18. The system of claim 16, wherein the transform comprises a discrete cosine transform.

19. The system of claim 16, wherein each block is represented as a matrix and for each block in the set of blocks, embedding a sub-set of watermark bits from a set of watermark bits into the block based on the parameters comprises:
processing the matrix to provide a set of matrices; and
embedding at least one watermark bit into a value of a matrix in the set of matrices.

20. The system of claim 19, wherein processing the matrix to provide a set of matrices comprises processing the matrix using singular value decomposition.
